(19) United States
(12) Patent Application Publication
(10) Pub. No.: US 2022/0018001 A1
(43) Pub. Date: Jan. 20, 2022

(54) SCALABLE MANUFACTURING OF COPPER NANOCOMPOSITES WITH UNUSUAL PROPERTIES

(71) Applicant: The Regents of the University of California, Oakland, CA (US)

(72) Inventors: Xiaochun Li, Los Angeles, CA (US); Chezheng Cao, Los Angeles, CA (US); Gongcheng Yao, Los Angeles, CA (US); Shuaihang PAN, Los Angeles, CA (US)

(73) Assignee: The Regents of the University of California, Oakland, CA (US)

(21) Appl. No.: 17/294,266

(22) PCT Filed: Nov. 14, 2019
(86) PCT No.: PCT/US2019/061485

§ 371 Date: May 14, 2021

Related U.S. Application Data
(60) Provisional application No. 62/767,892, filed on Nov. 15, 2018.

(51) Int. Cl. C22C 32/00; C22C 1/10; C22C 1/05

(52) U.S. Cl. CPC C22C 32/0052; B82Y 30/00; C22C 1/05; C22C 1/1036

(57) ABSTRACT

A copper-based nanocomposite includes a matrix including copper, and nanostructures dispersed in the matrix, wherein the nanocomposite has a yield strength of about 300 MPa or greater, and a ductility of about 5% or greater. Manufacturing methods of a copper-based nanocomposite are also provided.

### CROSS-REFERENCE TO RELATED APPLICATIONS

This application claims the benefit of U.S. Provisional Application No. 62/767,892, filed Nov. 15, 2018, the contents of which are incorporated herein by reference in their entirety.

### TECHNICAL FIELD

This disclosure generally relates to copper nanocomposites and manufacturing methods of such copper nanocomposites.

### BACKGROUND

High performance copper (Cu)-based materials are desired for various industrial applications, including high-speed railway contact wires, electric resistance welding electrodes, lead frames, and rotors for electric motors. Since pure Cu is very soft, it is frequently alloyed with other elements for strengthening. However, it is difficult, if not practically impossible, for Cu alloys to obtain a tensile (yield) strength higher than about 600 MPa with a good ductility while maintaining reasonable electrical conductivity and thermal conductivity. Additionally, alloying generally does not measurably alter the Young's modulus from pure Cu. Furthermore, Cu alloys generally soften at elevated temperatures due to de-alloying or coarsening of strengthening precipitates. Therefore, excellent mechanical properties with reasonable thermal and electrical properties for Cu-based materials remain highly demanded.

Numerous efforts have been made to tackle these challenges. For instance, severe plastic deformation (SPD) can be used to increase the strength of Cu and its alloys. However, this approach also significantly decreased the ductility. While nano-twinned Cu shows high strength and high electrical conductivity, the fabrication method (namely, electrodeposition) remains an obstacle for scaled-up production. Rapid cooling (e.g., gas atomization, melt spinning, and so forth) can be used to achieve high-strength Cu with high conductivity by obtaining a nanosized second phase from molten Cu alloys through phase transformation, as well as by obtaining in situ nanoparticles through reactions in molten Cu. However, the rapid cooling method is constrained in a sample size and a volume, thereby impeding its use for scaled-up production.

It is against this background that a need arose to develop the embodiments described herein.

### SUMMARY

In some embodiments, a Cu-based nanocomposite includes a matrix including Cu, and nanostructures dispersed in the matrix, wherein the nanocomposite has a yield strength of about 300 MPa or greater, and a ductility of about 5% or greater.

In additional embodiments, a manufacturing method of a Cu-based nanocomposite includes: (1) heating a matrix material including Cu to form a melt; (2) loading a mixture including a salt and nanostructures over a surface of the melt, such that the salt is heated to form a molten salt including the nanostructures dispersed therein; (3) agitating the melt to incorporate the nanostructures from the molten salt into the melt; and (4) cooling the melt including the nanostructures dispersed therein to form the nanocomposite.

In further embodiments, a manufacturing method of a Cu-based nanocomposite includes: (1) mixing a powder of a matrix material including Cu, a powder of a salt, and nanostructures to form a powder mixture; (2) heating the powder mixture to form an intermediate material including particles of the matrix material, the nanostructures dispersed in the particles of the matrix material, and the salt disposed between the particles of the matrix material; (3) removing the salt from the intermediate material; and (4) heating, under pressure, the particles of the matrix material including the nanostructures dispersed therein to form the nanocomposite.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1. Schematic illustration of salt-assisted self-incorporation of tungsten carbide (WC) nanostructures into Cu melt.

FIG. 2. Schematic of two-stage method for fabrication of Cu/WC nanocomposites.

FIG. 3. Scanning electron microscopy (SEM) images of: a) as-received WC nanoparticles; b) as-received Cu powders.

FIG. 4. SEM images of micro-Cu/WC powders before NaCl dissolution: a) cross-sections of Cu/about 40 vol. % WC micro-powders in NaCl; b) magnified image of boxed area in a).

FIG. 5. SEM images of a bulk Cu/about 40 vol. % WC nanocomposite at different magnifications.

FIG. 6. Size distribution of WC nanoparticles in Cu matrix.

FIG. 7. Micropillar compression tests for Cu/about 40 vol. % WC nanocomposite sample: a) SEM image of one micropillar from Cu/about 40 vol. % WC nanocomposite; b) engineered stress-strain curve of the micropillar compression test with SEM image showing the post-deformed micropillar as the inset.

FIG. 8. Hardness versus electrical conductivity of Cu/about 40 vol. % WC nanocomposite in comparison with other Cu alloys (most after substantial plastic deformation to improve hardness/strength, plotted with additional data for Cu—Mg alloys and other Cu-based materials).

### DETAILED DESCRIPTION

Embodiments of this disclosure are directed to an improved and cost-effective method to form Cu-based metal matrix nanocomposites with unusual mechanical, electrical and thermal properties. This method can pave a way to scalable manufacture of high performance Cu nanocomposites for a wide range of applications such as aerospace, transportation, energy, and electronics. In some embodiments, this processing route includes a salt-assisted self-incorporation method that can be readily applied to industrial production. Furthermore, with addition of nanostructures, Cu-based nanocomposites with different amounts of nanostructures can exhibit excellent comprehensive mechanical properties (e.g., strength, Young's modulus, ductility, and hardness) and functional properties (e.g., electrical conductivity and thermal conductivity).

In some embodiments, a manufacturing method of a Cu-based nanocomposite includes the following fabrication stages:

Tungsten carbide (WC) nanostructures (e.g., nanoparticles) are mixed with Borax (Na₂B₄O₇)-5 wt. % CaF₂ salt powders by a mechanical shaker (SK-O330-Pro) for about 1 hr. A volume fraction of nanostructures in the salt mixture is designed as about 10%. As shown in FIG. 1, substantially pure oxygen-free Cu ingots are melted at about 1250° C. in a graphite crucible by an induction heater. Inert argon (Ar) gas is purged on the molten Cu to avoid severe oxidation. The mixture of Na₂B₄O₇-5 wt. % CaF₂—WC nanostructures is loaded on a surface of the molten Cu. A graphite propeller is located below the Cu-salt interface and stirred at a speed of about 400 rpm for about 20 min to incorporate WC nanostructures into the Cu melt. Then the Cu melt is allowed to cool down to about 900° C. to allow Cu to solidify while the salt mixture remains in a liquid state. The molten salt mixture is poured out from the crucible to yield a Cu/WC ingot. A volume fraction of WC nanostructures in the resulting Cu-based nanocomposite is designed to be 0, about 5, about 10, and about 20 vol. %. The as-cast Cu-based nanocomposite ingot can be further processed for different applications, such as hot rolling, cold rolling, extrusion, and so forth.

In the salt-assisted self-incorporation method, the functions of molten salt are: (a) remove an oxide (copper oxide) layer on the Cu melt and provide a clean Cu-salt interface; (b) protect WC nanostructures from burning; and (c) serve as an intermediate media to allow transport of WC nanostructures from the molten salt to the Cu melt.

In other embodiments, a manufacturing method of a Cu-based nanocomposite includes the following fabrication stages:

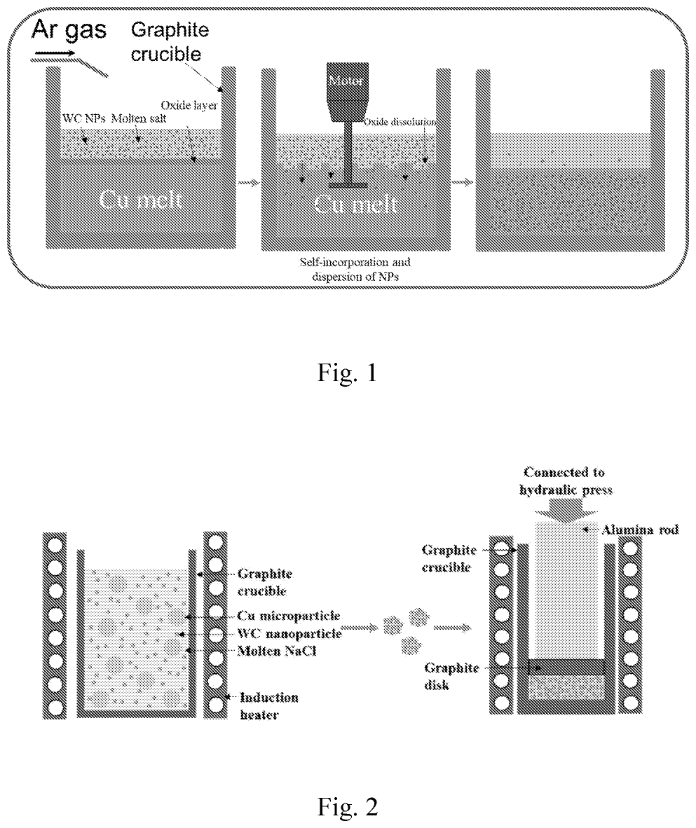

Cu/WC nanocomposites with high WC content are fabricated by a two-stage method as shown in FIG. 2: (1) Cu micro-powders with dispersed WC nanoparticles are fabricated by molten salt-assisted self-incorporation of the nanoparticles; and (2) bulk nanocomposites are produced by melting the powders under pressure after salt dissolution. More specifically, to fabricate designed Cu/about 40 vol. % WC micro-powders, substantially pure Cu powder (<about 10 μm), WC nanoparticles (average particle size of about 150-200 nm) and salt (NaCl) powder are mechanically mixed (about 1:2/3:6 by volume ratio) via shaking (SK-O330-Pro) for about 20 min. The mixed powders are heated to about 1200° C. at a heating rate of about 80° C./min in an induction heater under inert gas (Ar) protection and held for about 30 min with stirring using a graphite rod before cooling in the furnace. Then, the material is subjected to three rounds of soaking in deionized (DI) water to substantially fully dissolve NaCl before drying in a vacuum drying oven. Bulk Cu/about 40 vol. % WC nanocomposite is fabricated by melting the micro-powders at about 1500° C. for about 30 min with a pressure of about 7.5 MPa under inert gas (Ar) protection.

Cu nanocomposites can exhibit excellent mechanical properties. Uniformly dispersed nanostructures in metal matrices can effectively strengthen nanocomposites due to Orowan strengthening, load bearing resulting from well-dispersed nanoparticles, and the Hall-Petch effect as the nanostructures can refine grains of the matrices in the nanocomposites. On the other hand, although nanostructures have the potential to improve strength while maintaining or even improving the plasticity of metals, nanostructures can be difficult to disperse uniformly in metal matrices. Using the methods of embodiments of this disclosure, suitable nanostructures can be incorporated and self-dispersed in Cu and Cu alloys, simultaneously achieving an enhancement of hardness, strength, stiffness, and high-temperature stability. Besides, the mechanical properties of the nanocomposites can be tuned by adjusting an amount of the nano structures.

An average yield strength of a Cu/about 40 vol. % WC nanocomposite is determined to be 1020.7±244.3 MPa with a uniform plasticity of more than about 8%. The yield strength of the Cu/about 40 vol. % WC nanocomposite is much higher than other Cu alloys. The microhardness of Cu/WC nanocomposites almost increased linearly with the WC content. For a Cu/about 46 vol. % WC nanocomposite, the microhardness reached more than about 478 Vickers Pyramid Number (HV). The Young's modulus of the Cu/about 40 vol. % nanocomposite is determined to be 254.4±11.2 GPa, which is significantly enhanced compared to Cu and Cu alloys (about 115 GPa). The enhancement is attributed to the high Young's modulus of WC, the effective load bearing by WC, and its uniform dispersion in the nanocomposite.

In addition, some embodiments provide a mechanism to tune the functional properties of Cu and its alloys by the facile fabrication of Cu nanocomposites. The design flexibility and tunability of mechanical, electrical and thermal properties of Cu nanocomposites can open an important direction for metallurgy and material-related fields and broadens the applications of Cu-based materials.

In particular, the incorporation of nanostructures can tune the electrical properties of Cu nanocomposites. A main mechanism includes the effective scattering by nanostructures (e.g., with a radius of about 100 nm) as a secondary phase. A theoretical model is successfully established to reveal the relationship between the electrical conductivity and the nanostructure volume percentage (x). The electrical conductivity is mainly determined by the Fermi level mismatch (ΔE_{F}) at a metal matrix-nanostructure interface, following the distribution functions of energy states. The electrical conductivity is predicted to show an exponentially decaying trend with the increase in volume percentage of nanostructures as follows: σ∂exp(−(ΔE_{F}·x)/E_{F-metal}).

Based on the theoretical model and availability of nanostructures, two Cu nanocomposites are formed for experimental evaluation, namely Cu/WC (WC with a radius of about 100-200 nm) and Cu-40Zn/WC (Cu alloy with about 40 wt. % of zinc (Zn), and WC with a radius of about 100-200 nm). The above-mentioned processing method is used to obtain the Cu and Cu-40Zn nanocomposites of 0 to about 30 vol. % loadings of WC. The electrical conductivity is measured on a 4-Probe Station under a substantially constant temperature (about 25° C.), and the samples are about 100-200 μm in thickness for an accurate measurement. Both Cu/WC and Cu-40Zn/WC nanocomposites show a decaying trend, fitting the theoretical prediction with their electronic parameters including Fermi energy.

Moreover, the incorporation of nanostructures can provide an ability to tune the thermal properties of Cu nanocomposites. On one hand, nanostructures not only scatter electrons but also scatter phonons (with a mean free path of about 100 nm-1 μm); on the other hand, the enhanced mechanical properties resulting from the nanostructures give Cu and its alloys higher hardness, strength and Young's modulus, which benefit the phonon thermal transport. The introduction of nanostructures into a Cu metal matrix also increases the system entropy and gives rise to greater thermal coupling effects, which aid in tuning the thermal performance.

Based on this understanding, three Cu nanocomposites are formed for experimental evaluation, namely Cu/WC (WC with a radius of about 100-200 nm), Cu-40Zn/WC (Cu alloy with about 40 wt. % of Zn, and WC with a radius of about 100-200 nm) and Cu-60Ag/WC (Cu alloy with about 60 wt. % of silver (Ag), and WC with a radius of about 100-200 nm). Material property measurements, including differential scanning calorimetry (DSC) (scanning temperature of about 0-100° C., scanning speed of about 10° C./min) and Laser Flash Method (with a laser of wavelength of about 1070 nm and a laser pulse time of about 0.01 sec), are used to characterize the heat capacity and thermal conductivity for Cu and its alloy nanocomposites. For Cu/about 12.5 vol. % WC nanocomposite, the thermal conductivity changes to 304.1±2.3 W/(m·K). For both Cu-40Zn and Cu-60Ag alloy systems, the thermal conductivity is also tuned by the nanostructure incorporation. Moreover, Cu-40Zn/about 10 vol. % WC and Cu-60Ag/about 10 vol. % WC systems exhibit an increase in the thermal conductivity to about 120 W/(m·K) and about 440 W/(m·K), respectively.

Advantages of embodiments of this disclosure include:
The manufacturing method is a scalable fabrication process.
Breaks the technical dilemma between attaining desirable mechanical properties and ability to tune electrical and thermal conductivities.
Excellent mechanical, thermal, and electrical properties.

### EXAMPLE EMBODIMENTS

In some embodiments, a Cu-based nanocomposite includes a matrix including Cu, along with reinforcing nanostructures dispersed in the matrix. In some embodiments, the matrix includes Cu and one or more additional metals. In some embodiments, Cu is included in the matrix as a majority component (by weight), and the one or more additional metals are included in the matrix as minority components (by weight). In some embodiments, Cu is included in the matrix as a minority component (by weight), and the one or more additional metals are included in the matrix as majority components (by weight). Examples of the one or more additional metals include Zn, Ag, and aluminum (Al), amongst others.

In some embodiments, nanostructures can have at least one dimension in a range of about 1 nm to about 1000 nm, such as about 1 nm to about 500 nm, about 1 nm to about 400 nm, about 1 nm to about 300 nm, about 1 nm to about 200 nm, or about 1 nm to about 100 nm. In some embodiments, the nanostructures can have at least one average or median dimension in a range of about 1 nm to about 500 nm, about 1 nm to about 400 nm, about 1 nm to about 300 nm, about 1 nm to about 200 nm, or about 1 nm to about 100 nm. In some embodiments, the nanostructures can include nanoparticles having an aspect ratio of about 5 or less, or about 4 or less, or about 3 or less, or about 2 or less and having generally spherical or spheroidal shapes, although other shapes and configurations of nanostructures are contemplated, such as nanofibers and nanoplatelets. In the case of nanoparticles of some embodiments, the nanoparticles can have at least one dimension (e.g., an effective diameter which is twice an effective radius) or at least one average or median dimension (e.g., an average effective diameter which is twice an average effective radius) in a range of about 1 nm to about 1000 nm, such as about 1 nm to about 500 nm, about 1 nm to about 400 nm, about 1 nm to about 300 nm, about 1 nm to about 200 nm, or about 1 nm to about 100 nm.

In some embodiments, nanostructures can include one or more ceramics, although other nanostructure materials are contemplated, such as metals. Examples of suitable nanostructure materials include metal oxides (e.g., alkaline earth metal oxides, post-transition metal oxides, and transition metal oxides, such as aluminum oxide (Al₂O₃), magnesium oxide (MgO), titanium oxide (TiO₂), and zirconium oxide (ZrO₂)), non-metal oxides (e.g., metalloid oxides such as silicon oxide (SiO₂)), metal carbides (e.g., transition metal carbides, such as titanium carbide (TiC), niobium carbide (NbC), chromium carbide (Cr₃C₂), nickel carbide (NiC), hafnium carbide (HfC), vanadium carbide (VC), tungsten carbide (WC), and zirconium carbide (ZrC)), non-metal carbides (e.g., metalloid carbides such as silicon carbide (SiC)), metal silicides (e.g., transition metal silicides, such as titanium silicide (TiSi)), metal borides (e.g., transition metal borides, such as titanium boride (TiB₂), zirconium boride (ZrB₂), hafnium boride (HfB₂), vanadium boride (VB₂), and tungsten boride (W₂B₅)), metal nitrides (e.g., transition metal nitrides), non-metal nitrides (e.g., metalloid nitrides such as silicon nitride), metals, alloys, mixtures, or other combinations of two or more of the foregoing. Particular examples of suitable nanostructure materials include transition metals and transition metal carbides (e.g., W and WC), amongst other transition metal-containing ceramics.

In some embodiments, a Cu-based nanocomposite can include nanostructures at a high volume percentage of, for example, greater than about 3%, such as about 5% or greater, about 6% or greater, about 7% or greater, about 8% or greater, about 9% or greater, about 10% or greater, about 15% or greater, or about 20% or greater, and up to about 40% or greater, or up to about 50% or greater.

In some embodiments, a Cu-based nanocomposite can have a high yield strength of, for example, about 300 MPa or greater, such as about 400 MPa or greater, about 500 MPa or greater, about 600 MPa or greater, about 700 MPa or greater, about 800 MPa or greater, or about 900 MPa or greater, and up to about 1000 MPa or greater.

In some embodiments, a Cu-based nanocomposite can have a high microhardness of, for example, about 120 HV or greater, such as about 200 HV or greater, about 250 HV or greater, about 300 HV or greater, about 350 HV or greater, about 400 HV or greater, or about 450 HV or greater, and up to about 500 HV or greater.

In some embodiments, a Cu-based nanocomposite can have a high value for the Young's modulus of, for example, about 130 GPa or greater, such as about 150 GPa or greater, about 180 GPa or greater, about 200 GPa or greater, or about 230 GPa or greater, and up to about 250 GPa or greater.

In some embodiments, a Cu-based nanocomposite can have a high ductility of, for example, about 3% or greater in terms of percent elongation before rupture, such as about 4% or greater, about 5% or greater, about 6% or greater, about 7% or greater, or about 8% or greater, and up to about 10% or greater, or up to about 20% or greater.

In some embodiments, a Cu-based nanocomposite can have a thermal conductivity of, for example, about 80 W/(m·K) or greater, such as about 100 W/(m·K) or greater, about 120 W/(m·K) or greater, about 150 W/(m·K) or greater, or about 200 W/(m·K) or greater, and up to about 300 W/(m·K) or greater, or up to about 400 W/(m·K) or greater.

In some embodiments, a Cu-based nanocomposite can have an electrical conductivity of about 5 International Annealed Copper Standard (IACS) or greater, such as about 10 IACS or greater, about 15 IACS or greater, or about 20 IACS or greater, and up to about 40 IACS or greater, or up to about 60 IACS or greater.

In some embodiments, a manufacturing method of a Cu-based nanocomposite includes: (1) heating a matrix material including Cu to form a melt; (2) loading a mixture including a salt and reinforcing nanostructures over a surface of the melt, such that the salt is heated to form a molten salt including the nanostructures dispersed therein; (3) agitating the melt to incorporate the nanostructures from the molten salt into the melt; and (4) cooling the melt including the nanostructures dispersed therein to form the nanocomposite.

In some embodiments of the method, a matrix material includes Cu and one or more additional metals. In some embodiments, Cu is included in the matrix material as a majority component (by weight), and the one or more additional metals are included in the matrix material as minority components (by weight). In some embodiments, Cu is included in the matrix material as a minority component (by weight), and the one or more additional metals are included in the matrix material as majority components (by weight). Examples of the one or more additional metals include Zn, Ag, and Al, amongst others.

In some embodiments of the method, features of nanostructures are as described for the foregoing embodiments of the Cu-based nanocomposite.

In some embodiments of the method, the method includes specifying a target electrical conductivity of the nanocomposite, and incorporating the nanostructures into the nanocomposite at an amount (e.g., a volume percentage) according to the target electrical conductivity.

In some embodiments of the method, the method includes specifying a target thermal conductivity of the nanocomposite, and incorporating the nanostructures into the nanocomposite at an amount (e.g., a volume percentage) according to the target thermal conductivity.

In additional embodiments, a manufacturing method of a Cu-based nanocomposite includes: (1) mixing a powder of a matrix material including Cu, a powder of a salt, and reinforcing nanostructures to form a powder mixture; (2) heating the powder mixture to form an intermediate material including particles of the matrix material, the nanostructures dispersed in the particles of the matrix material, and the salt disposed between the particles of the matrix material; (3) removing the salt from the intermediate material by dissolution; and (4) heating, under pressure, the particles of the matrix material including the nanostructures dispersed therein to form the nanocomposite.

In some embodiments of the method, a matrix material includes Cu and one or more additional metals. In some embodiments, Cu is included in the matrix material as a majority component (by weight), and the one or more additional metals are included in the matrix material as minority components (by weight). In some embodiments, Cu is included in the matrix material as a minority component (by weight), and the one or more additional metals are included in the matrix material as majority components (by weight). Examples of the one or more additional metals include Zn, Ag, and Al, amongst others.

In some embodiments of the method, features of nanostructures are as described for the foregoing embodiments of the Cu-based nanocomposite.

In some embodiments of the method, heating, under pressure, the particles of the matrix material includes applying a pressure of about 1 MPa or greater, such as about 2 MPa or greater, about 3 MPa or greater, about 4 MPa or greater, about 5 MPa or greater, about 6 MPa or greater, or about 7 MPa or greater, and up to about 8 MPa or greater, or up to about 10 MPa or greater.

In some embodiments of the method, the particles of the matrix material can have at least one dimension in a range of about 0.5 μm to about 100 μm, such as about 1 μm to about 50 μm, about 1 μm to about 40 nm, about 1 μm to about 30 μm, about 1 μm to about 20 μm, or about 1 μm to about 10 μm. In some embodiments, the particles can have at least one average or median dimension in a range of about 0.5 μm to about 100 μm, about 1 μm to about 50 μm, about 1 μm to about 40 nm, about 1 μm to about 30 μm, about 1 μm to about 20 μm, or about 1 μm to about 10 μm.

### Example

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

High-Performance Copper Reinforced with Dispersed Nanoparticles

Overview:

Copper (Cu) has high electrical conductivity and has use for many industrial applications. However, pure Cu is very soft and improving the mechanical properties of Cu comes at the great expense of electrical and thermal conductivity. In this example, high-performance Cu with superior mechanical properties and reasonable electrical/thermal conductivity was fabricated using a scalable two-stage method. First, Cu micro-powders with uniformly dispersed tungsten carbide (WC) nanoparticles were created by a molten salt-assisted self-incorporation process. A bulk nanocomposite was then obtained by melting the powders under pressure. The as-solidified Cu with about 40 vol. % uniformly dispersed WC nanoparticles exhibits high hardness, a yield strength over about 1000 MPa, a Young's modulus of over about 250 GPa, and reasonable electrical and thermal conductivity.

### Introduction

High-performance copper (Cu)-based materials are desired for various industrial applications, including high-speed railway contact wires, electric resistance welding electrodes, lead frames, and rotors for electric motors. Since pure Cu is very soft, it is frequently alloyed with other elements for strengthening. However, it is difficult for Cu alloys to obtain a tensile strength higher than about 600 MPa with a good ductility while maintaining reasonable electrical and thermal conductivity. Additionally, alloying does not alter the Young's modulus from pure Cu. Furthermore, Cu alloys soften at elevated temperatures due to de-alloying or coarsening of the strengthening precipitates.

Incorporating a strengthening phase (e.g., ceramic nanoparticles) into Cu to form a metal matrix nanocomposite (MMNC) is one way to create high-performance Cu-based materials. One promising candidate of ceramic nanoparticles is tungsten carbide (WC). WC has a high hardness (about 22 GPa) and high Young's modulus (about 620-720 GPa). Additionally, the wetting between molten Cu and WC is very good with a low wetting angle less than about 10° at about 1200° C., beneficial for a good interfacial bonding between Cu and WC. Furthermore, there is no reaction between Cu and WC, making it thermally stable in molten Cu.

Powder metallurgy can be used to fabricate MMNCs. However, the distribution and dispersion of the nanofillers in MMNCs is highly dependent on the mechanical mixing. It is hard to obtain a uniform dispersion of the fillers in the matrices, as particles tend to form clusters due to their large surface area, which can negatively impact the properties of the resulting nanocomposites. For instance, WC nanoparticles in Cu/WC nanocomposites prepared by powder metallurgy can agglomerate so severely in the Cu matrix that the strength of the Cu/3 wt. % WC nanocomposite is even less than its Cu/2 wt. % WC counterpart. Consequently, the powder metallurgy method generally cannot be used to fabricate nanocomposites with a high percentage of the strengthening phase for favorable properties.

Other methods can be used to fabricate Cu/WC nanocomposites with constrained success. Cu/WC/graphene nanocomposites can be produced by electrophoretic deposition. However, this method is more suitable for producing films rather than bulk materials. Additionally, Cu matrix composites with WC-Co submicron particles can be processed by direct laser sintering, but can result in significant particulate aggregations due to constrained liquid formation and high viscosity as well as a reduced Marangoni effect.

In this example, Cu nanocomposite with dispersed WC nanoparticles was successfully fabricated. Microstructure and properties including microhardness, yield strength, Young's modulus, electrical conductivity and thermal conductivity of the samples were investigated. Results showed that a uniform dispersion of dense WC nanoparticles in the Cu matrix is achieved. A significant enhancement of hardness/strength and Young's modulus is achieved, while the conductivities are maintained at reasonable levels. The Cu/WC nanocomposites can provide high performance for widespread applications. Moreover, the scalable manufacturing method can be readily extended to fabricate Cu matrix nanocomposites with other suitable nanoparticles and various nanoparticle loadings for industrial production.

### Experimental

Nanocomposite Fabrication

Cu/WC nanocomposites with high WC content were fabricated by a two-stage method as shown in FIG. 2: (1) Cu micro-powders with dispersed WC nanoparticles were fabricated by molten salt-assisted self-incorporation of the nanoparticles; and (2) bulk nanocomposites were produced by melting the powders under pressure after salt dissolution. More specifically, to fabricate the designed Cu/about 40 vol. % WC micro-powders, substantially pure Cu powders (Sigma-Aldrich, <about 10 μm, about 99%), WC nanoparticles (US Research Nanomaterials, average particle size of about 150-200 nm, about 99.9%) and NaCl particles (Fisher Chemical, about 99.5%) were mechanically mixed (about 1:2/3:6 by volume ratio) via shaking (SK-0330-Pro) for about 20 min. The mixed powders were heated to about 1200° C. at a heating rate of about 80° C./min in an induction heater under argon protection and held for about 30 min with manual stirring using a graphite rod before cooling in the furnace. Then, the material underwent three rounds of soaking in deionized (DI) water to substantially fully dissolve NaCl before drying in a vacuum drying oven. Bulk Cu/about 40 vol. % WC nanocomposite samples were fabricated by melting the micro-powders at about 1500° C. for about 30 min with a pressure of about 7.5 MPa under argon protection.

Microstructure Characterization

The microstructure of both Cu micro-powders and bulk nanocomposites were examined by scanning electron microscopy (SEM, ZEISS Supra 40VP). To reveal the WC nanoparticles, the SEM samples for the bulk nanocomposite were cleaned by low-angle ion_milling at about 4° and about 4.5 kV for about 3.5 h (Model PIPS 691, Gatan) following manual grinding and polishing. The SEM samples for observing cross-sections of micro-powders were prepared by encapsulating a piece of solidified NaCl and micro-powders in graphite-based conductive mounting powders (Allied, #155-20015), followed by grinding and polishing. The micropillars for mechanical testing were observed by dual-beam FIB-SEM (FEI Nova 600) with a tilted angle of about 52°.

Mechanical Characterization

Compression tests using an MTS nanoindenter with a strain rate of about 5×10⁻² s⁻¹ and about 3 μm compression depth limit at room temperature were conducted on micropillars (about 3-4 μm in diameter and about 9-12 μm in length), which were machined by focused ion beam (FIB, FEI Nova 600) from the bulk nanocomposites. The yield strength was obtained by an average of at least three measurements. Young's modulus was measured by the same nanoindenter machine with a Berkovich tip under the Young's modulus measuring mode with an indent depth of about 2 μm. The micro-hardness was determined by a LM 800AT micro-hardness tester using a load of about 200 gf with about 10 s dwell time. Each Young's modulus and microhardness data represent ten measurements at random spots at room temperature.

Conductivity Measurements

Thermal conductivity of the sample was measured by the laser flash method at room temperature. First, thermal diffusivity was calculated by Eq. 1 based on one-dimensional heat diffusion:

$$α = \frac{0.139 {L}^{2}}{{t}_{0.5}} \qquad ( 1 )$$

where α is the thermal diffusivity, L is the sample length, and t_{0.5} is the time for the backside temperature of the sample to rise by half of the maximum temperature change. In this experiment, the sample length was set to be about 2 cm with a cross-section of about 2 mm×2 mm. Finally, the thermal conductivity was calculated by Eq. 2:

k=αρcₚ (2)

where k is the thermal conductivity, ρ is the density, and cₚ is the specific heat. To obtain the specific heat capacity value of the nanocomposite, differential scanning calorimetry (DSC, PerkinElmer DSC 8000) was used to experimentally measure the heat capacity at a temperature scan rate of about 10° C./min. Electrical conductivity of the sample was measured on Prometrix Omnimap RS-35 4 point probe at room temperature. Each conductivity data represents at least three measurements.

Results:

Microstructure

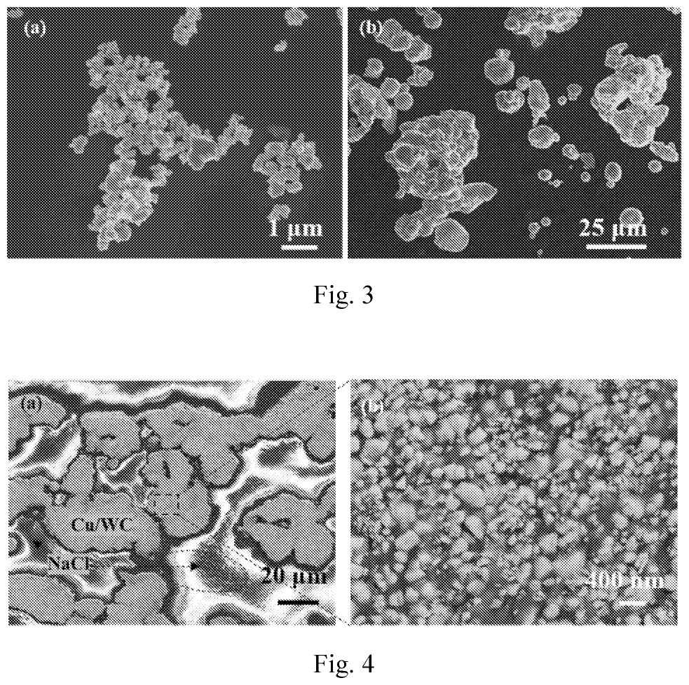

The morphologies of as-received WC nanoparticles and Cu powders are shown in FIG. 3. As indicated in FIG. 4a, the Cu/WC nanocomposite micro-powders with NaCl in between were created by the molten salt-assisted self-incorporation process. Cross-sections of the Cu/about 40 vol. % WC micro-powders (FIG. 4b) show a dense and uniform distribution of WC nanoparticles (bright areas in FIG. 4b) in the Cu matrix (dark areas in FIG. 4b). The incorporation mechanism of WC nanoparticles into Cu is discussed below. Where WC nanoparticles stay depends on the Gibbs energy, which is mainly determined by the interfacial energy in this case. Qualitatively, WC is a metallic ceramic, which tends to wet metals (metallic bond) more than salts (ionic bond). The good wettability between WC and molten Cu is indicated by a low contact angle. Moreover, molten salt acts as a protective layer to reduce oxidation of both WC nanoparticles and molten Cu. Molten salt can also partially dissolve metal oxides to allow direct contact between WC nanoparticles and molten Cu and consequent incorporation of WC nanoparticles into Cu.

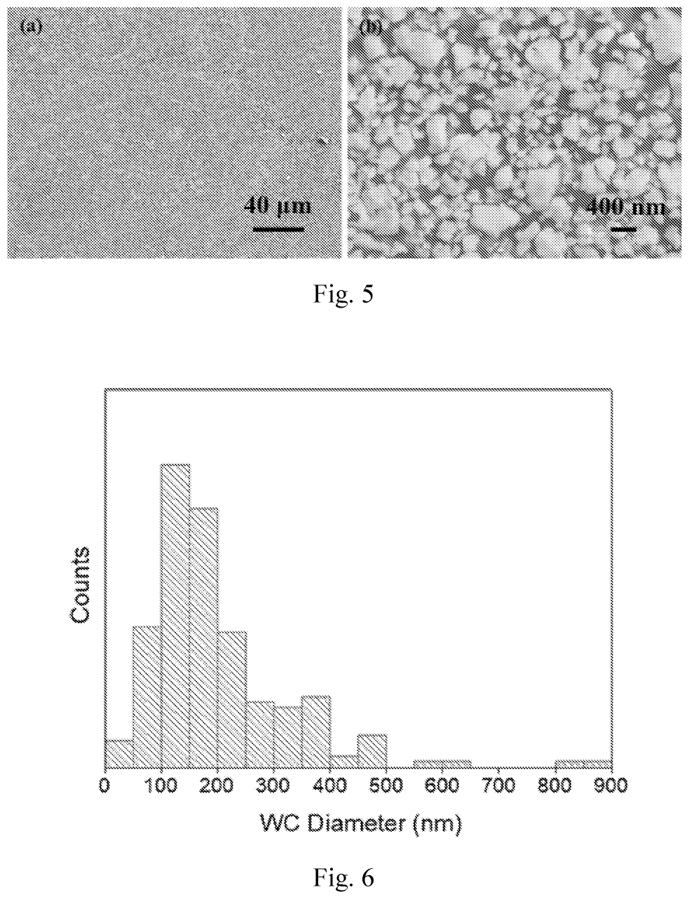

Microstructures of the bulk Cu/about 40 vol. % WC nanocomposite are shown in FIG. 5. The dense WC nanoparticles are uniformly distributed and well-dispersed in the Cu matrix instead of clustering even though the WC content is very high. Additionally, the bulk nanocomposite is free of porosity, demonstrating the feasibility of producing bulk samples by melting the nanocomposite micro-powders under low pressure. Histograms representing the size distribution of WC nanoparticles (by image processing of FIG. 5b) in Cu matrix are shown in FIG. 6. The average WC diameter in Cu matrix is 197.5±126.4 nm. The mechanism for bulk material formation from the initial nanocomposite micro-powders is inferred to be that, under the high temperature, Cu from each powder diffuses to the powder's surface and the applied pressure binds the powders together. The reason the Cu/about 40 vol. % WC melt can sustain the pressure instead of being squeezed out is that the viscosity of molten metals can be dramatically increased when more nanoparticles are incorporated, which is beneficial for the current method to form bulk nanocomposites.

Properties

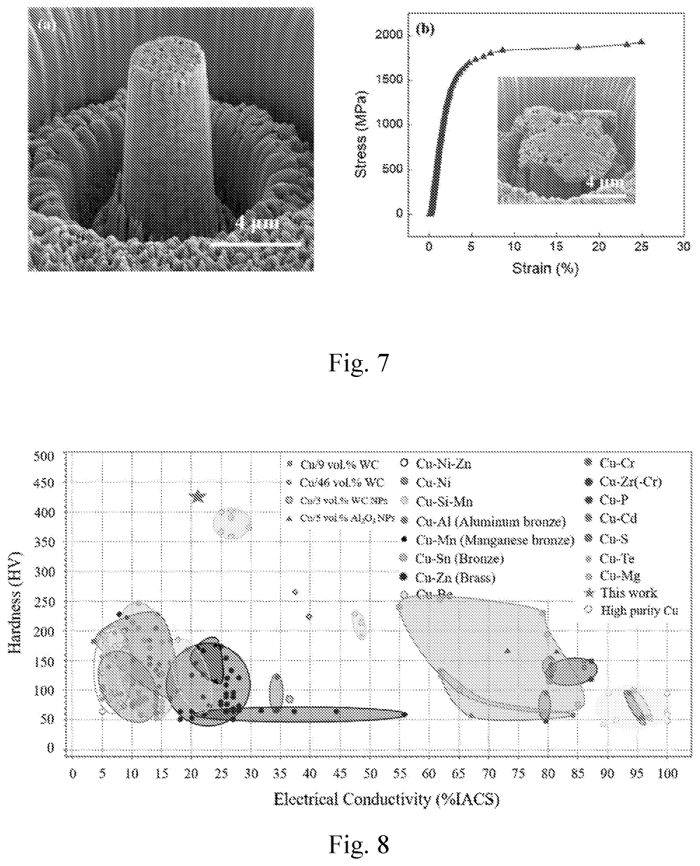

The Cu/about 40 vol. % WC nanocomposite should have excellent mechanical properties due to the dense well-dispersed WC nanoparticles. To investigate the strength of the nanocomposite, micropillar compression tests were conducted. A SEM image of one micropillar is shown in FIG. 7a. Whereas FIG. 5 showed the microstructure of one plane, FIG. 7a shows that WC nanoparticles are globally well-dispersed and distributed in the pillar. Corresponding engineering stress-strain curve of the compression test is shown in FIG. 7b. The micropillars were strained to failure and the typical post-deformed picture is shown as the inset of FIG. 7b. The average yield strength of the nanocomposite was 1020.7±244.3 MPa with a uniform plasticity of more than about 8%. The yield strength of the Cu/about 40 vol. % WC nanocomposite is much higher than most other reported Cu alloys.

The average microhardness of the bulk Cu/about 40 vol. % WC nanocomposite was 426.0±47.2 HV. Considering the microhardness of annealed pure Cu was about 50 HV, a significant strengthening effect was achieved. Strengthening efficiency (R) of reinforcements in MMNCs is specified as:

R=(H_{C}=Hₘ)/(x·Hₘ) (3)

where H_{c} is microhardness (HV) of the nanocomposite, Hₘ is the microhardness of the matrix (the microhardness of pure Cu was used for Hₘ), and x is the volume percentage of the strengthening phase. The strengthening efficiency for Cu/about 40 vol. % WC nanocomposite was about 18.8. The superior strengthening can be attributed to the Orowan strengthening, load bearing resulting from populous well-dispersed WC nanoparticles and the Hall-Petch effect resulting from refined grains of Cu matrix as nanoparticles can refine grains of the matrix in MMNCs.

Young's modulus of the nanocomposite was 254.4±11.2 GPa, which is significantly enhanced compared to pure Cu. The enhancement is attributed to the high Young's modulus of WC, the effective load bearing by WC, and its uniform dispersion in the nanocomposite. The dramatically increased Young's modulus achieved with nanocomposites shows the advantage this strategy has over alloying, which does not effectively increase Cu's Young's modulus (about 115 GPa).

The electrical and thermal conductivity of the Cu/WC nanocomposite was decreased compared to pure Cu, but comparable to other Cu alloys. The thermal conductivity was 155.7±19.5 W m⁻¹ K⁻¹ for Cu/about 40 vol. % WC with the specific heat capacity at about 25° C. measured to be 0.239±0.002 J/(g ° C.). Its electrical conductivity was 21.0±0.3% International Annealed Copper Standard (IACS). There are multiple reasons for the decreased thermal and electrical conductivities of the nanocomposite compared to pure Cu. First, WC has lower thermal and electrical conductivity values than pure Cu. Moreover, the addition of WC to the Cu matrix introduces imperfections in the Cu lattice, such as interfaces and grain boundaries (from the refining of Cu grains), which act as scattering centers and lower electron motion efficiency.

Discussion

Nanoparticle Dispersion and Self-Stabilization Mechanism

The underlying mechanism for the dispersion of WC nanoparticles in Cu as shown in FIG. 7a can be explained by the thermally activated nanoparticle dispersion and self-stabilization theory in molten metals. Three interactions between nanoparticles are considered: interfacial energy, van der Waals potential, and Brownian motion energy. Good wetting between molten metal and nanoparticles creates an energy barrier to reduce the possibility of nanoparticles contacting with each other. The reason is that when two nanoparticles approach to a distance that the molten metal is squeezed out, the metal-nanoparticle interface will be replaced by the nanoparticle surface, which has higher energy. Thermal energy makes nanoparticles disperse by Brownian motion. Nanoparticles are dispersed and stabilized in molten metals by synergistically reducing attractive van der Waals forces between the nanoparticles, providing high thermal energy for the nanoparticles to disperse, and creating a high energy barrier to prevent clustering. In this system, the small WC particle size and their conductive nature result in small van der Waals attraction. Additionally, the high processing temperature provides the nanoparticles with high thermal energy. Finally, the good wetting between Cu and WC produces the high energy barrier.

The energy barrier (W_{barrier}), thermal energy (E_{b}), and van der Waals interaction (W_{vdw}) can be calculated by Eqs. 4-6, respectively:

$$\begin{matrix}{W}_{barrier} = S ( {σ}_{NP} - {σ}_{NP - liquid} ) = S {σ}_{liquid} cos θ , & ( 4 ) \\ {E}_{b} = kT , & ( 5 ) \\ {W}_{vdw} = - \frac{{( \sqrt{{A}_{NP}} - \sqrt{{A}_{liquid}} )}^{2}}{6 D} \frac{R}{2} , & ( 6 )\end{matrix}$$

where S is the effective area (S=πRD₀, D₀=0.2 nm); σ_{NP} is the surface energy of nanoparticles; σ_{NP-liquid} is the interfacial energy between nanoparticles and molten metal; σ_{liquid} is the molten metal surface tension; θ is the contact angle of molten metal on nanoparticle surface; k is the Boltzmann constant; T is the absolute temperature; A is the Hamaker constant; R is the nanoparticle radius; and D is the distance between two nanoparticles. Equation (6) is effective when two nanoparticles interact in molten Cu with D approximately larger than two atomic layers (about 0.4 nm).

In this example, estimation is made of W_{barrier} to be about 7.3×10⁴ zJ, using R=about 98.75 nm, θ=about 10°, σ_{liquid}=about 1.2 J/m² at about 1500° C. At about 1500° C., E_{b} is about 24.5 zJ. The energy barrier is much higher than the thermal energy. To estimate W_{vdw}, A_{Cu} is about 410 zJ and A_{WC} could range from about 200 to about 500 zJ since WC is a conductive ceramic. W_{vdw} could range from about −767 to 0 zJ. W_{barrier} would always be much higher than E_{b} and W_{vdw} for stabilization of dispersed WC nanoparticles in Cu melt.

As mentioned above, the wettability between molten metal and nanoparticles allows for the successful incorporation and dispersion of nanoparticles into molten metal. Adding other elements can improve the wettability in some cases. Therefore, further extensions can apply the current method to the fabrication of Cu MMNCs reinforced by nanoparticles that have good properties (such as lightweight, highly conductive, and so forth) but initially do not have a good wettability with Cu with the help of adding other alloying elements.

Theoretical Calculation of Mechanical and Electrical Properties

The Orowan strengthening can be estimated by Eq. 7:

$$Δ {σ}_{Orowan} = \frac{0.13 G b}{{d}_{p} [ \sqrt[3]{( \frac{1}{2 {V}_{p}} )} - 1 ]} ln \frac{{d}_{p}}{2 b} , \qquad ( 7 )$$

where G and b are the shear modulus and Burger's vector of the matrix, dₚ and Vₚ are the diameter and volume fraction of nanoparticles. In this example, using G=about 47.7 GPa, b=about 0.256 nm, Vₚ=about 0.4, and dₚ=about 197.5 nm, the calculated Orowan strengthening is about 620 MPa. The total strengthening in the as-solidified Cu/about 40 vol. % WC nanocomposite is about 944 MPa using annealed pure Cu's yield strength of about 76 MPa as a counterpart for simplicity. The strengthening from the formation of geometrically requisite dislocations may be neglected. It is inferred that the rest of the yield strength increase (about 324 MPa) originates from the load-bearing effect of WC nanoparticles and the Hall-Petch effect resulting from refined grains of Cu matrix compared with pure Cu.

According to the Maxwell model, the upper bound electrical resistivity of composites can be estimated by Eq. 8:

$${ρ}_{c} = {ρ}_{m} [ \frac{1 + 2 \frac{{ρ}_{m}}{{ρ}_{p}} - 2 {V}_{p} ( \frac{{ρ}_{m}}{{ρ}_{p}} - 1 )}{1 + 2 \frac{{ρ}_{m}}{{ρ}_{p}} + 2 {V}_{p} ( \frac{{ρ}_{m}}{{ρ}_{p}} - 1 )} ] \qquad ( 8 )$$

where ρ_{c}, ρₘ, and ρₚ are the electrical resistivity of the nanocomposite, matrix, and nanoparticles. Vₚ is the volume fraction of nanoparticles. Electrical resistivity values of Cu and WC at about 20° C. are about 1.7241μΩ cm and about 22.0μΩ cm. The electrical resistivity of the nanocomposites in this example is estimated to be about 7.8μΩ cm (about 22.1% IACS). The experimental value (about 21.0% IACS) is close to the theoretical value.

Comparison with Other Fabrication Methods for MMNCs

The method of this example for fabricating MMNCs has several advantages over other methods. First, the method produces a metal matrix with a high content of uniformly dispersed nanoparticles, solving the problem of incorporation and dispersion of nanoparticles into metal matrices. Additionally, the pressure employed to fabricate MMNCs in this example was much lower than the pressures for cold compaction in comparative powder metallurgy (several hundreds of MPa). In comparative powder metallurgy methods, WC particles and Cu powders are mixed mechanically by ball milling before compaction, which can also introduce impurities from milling balls and container walls into the system.

Comparison with Cu Alloys

The hardness versus electrical conductivity comparison of the Cu/about 40 vol. % WC nanocomposite compared to Cu alloys (data from CES EduPack 2017 software and additional data for Cu—Mg alloys and other Cu-based materials including Cu/5 vol. % Al₂O₃ nanocomposites, Cu/3 vol. % WC nanocomposite, Cu/9 vol. % microsized WC composites with and without cold rolling 64% in length, and Cu/46 vol. % microsized WC composites) is shown in FIG. 8. As few Cu/WC nanocomposites are reported, Cu matrix composites reinforced by WC microparticles are also included in FIG. 8. High purity copper possesses high electrical conductivity but low hardness. Most Cu alloys achieve increased hardness values, but the electrical conductivity is significantly deteriorated. The Cu/WC nanocomposites in this example provides better performance than most other Cu alloys that mostly have already undergone significant plastic deformation. The Cu/WC nanocomposites would have excellent high-temperature stability due to the high stability of WC nanoparticles in the Cu matrix, which would be an advantage over Cu and its alloys. The Cu/WC nanocomposites in this example are also distinguished from above-mentioned Cu-based composites in terms of the much higher strengthening effect. Further improvements, such as applying work hardening to the Cu/WC nanocomposites, can be made to achieve even better performance.

Conclusions:

Copper with a high content of uniformly distributed and dispersed WC nanoparticles is successfully fabricated. The hardness/strength of the Cu/WC nanocomposites is significantly enhanced while maintaining reasonable electrical and thermal conductivity. The scalable two-stage method can be utilized to fabricate high-performance Cu nanocomposites.

As used herein, the singular terms “a,” “an,” and “the” may include plural referents unless the context clearly dictates otherwise. Thus, for example, reference to an object may include multiple objects unless the context clearly dictates otherwise.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common characteristics.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be “substantially” or “about” the same as a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “size” refers to a characteristic dimension of an object. Thus, for example, a size of an object that is spherical or spheroidal can refer to a diameter of the object. In the case of an object that is non-spherical or non-spheroidal, a size of the object can refer to a diameter of a corresponding spherical or spheroidal object, where the corresponding spherical or spheroidal object exhibits or has a particular set of derivable or measurable properties that are substantially the same as those of the non-spherical or non-spheroidal object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

As used herein, the term “nanostructure” refers to an object that has at least one dimension in a range of about 1 nm to about 1000 nm. A nanostructure can have any of a wide variety of shapes, and can be formed of a wide variety of materials. Examples of nano structures include nanofibers, nanoplatelets, and nanoparticles.

As used herein, the term “nanoparticle” refers to a nanostructure that is generally or substantially spherical or spheroidal. Typically, each dimension of a nanoparticle is in a range of about 1 nm to about 1000 nm, and the nanoparticle has an aspect ratio of about 5 or less, such as about 3 or less, about 2 or less, or about 1.

As used herein, the term “nanofiber” refers to an elongated nanostructure. Typically, a nanofiber has a lateral dimension (e.g., a width) in a range of about 1 nm to about 1000 nm, a longitudinal dimension (e.g., a length) in a range of about 1 nm to about 1000 nm or greater than about 1000 nm, and an aspect ratio that is greater than about 5, such as about 10 or greater.

As used herein, the term “nanoplatelet” refers to a planar-like, nanostructure.

Additionally, concentrations, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a range of about 1 to about 200 should be understood to include the explicitly recited limits of about 1 and about 200, but also to include individual values such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

1. A copper-based nanocomposite comprising:
a matrix including copper; and
nanostructures dispersed in the matrix,
wherein the nanocomposite has a yield strength of about 300 MPa or greater, and a ductility of about 5% or greater.

2. The nanocomposite of claim 1, wherein the yield strength is about 500 MPa or greater, or about 700 MPa or greater.

3. The nanocomposite of claim 1, wherein the ductility is about 6% or greater, or about 8% or greater.

4. The nanocomposite of claim 1, having a microhardness of about 200 HV or greater.

5. The nanocomposite of claim 4, wherein the microhardness is about 300 HV or greater, or about 400 HV or greater.

6. The nanocomposite of claim 1, having a value for the Young's modulus of about 130 GPa or greater.

7. The nanocomposite of claim 6, wherein the value for the Young's modulus is about 200 GPa or greater, or about 250 GPa or greater.

8. The nanocomposite of claim 1, having an electrical conductivity of about 10 IACS or greater.

9. The nanocomposite of claim 1, wherein the matrix includes copper and at least one additional metal different from copper.

10. The nanocomposite of claim 9, wherein the at least one additional metal is selected from zinc, silver, and aluminum.

11. The nanocomposite of claim 1, wherein the nanostructures include a ceramic.

12. The nanocomposite of claim 11, wherein the ceramic is a transition metal-containing ceramic.

13. The nanocomposite of claim 12, wherein the transition metal-containing ceramic is tungsten carbide.

14. The nanocomposite of claim 1, wherein the nanostructures are dispersed in the matrix at a volume fraction of about 5% or greater of the nanocomposite.

15. The nanocomposite of claim 14, wherein the volume fraction of the nanostructures in the nanocomposite is about 10% or greater, or about 15% or greater.

16. A manufacturing method of a copper-based nanocomposite, comprising:
heating a matrix material including copper to form a melt;
loading a mixture including a salt and nanostructures over a surface of the melt, such that the salt is heated to form a molten salt including the nanostructures dispersed therein;
agitating the melt to incorporate the nanostructures from the molten salt into the melt; and
cooling the melt including the nanostructures dispersed therein to form the nanocomposite.

17. The method of claim 16, wherein the matrix material includes copper and at least one additional metal different from copper.

18. The method of claim 16, further comprising specifying a target electrical conductivity of the nanocomposite, and incorporating the nanostructures into the nanocomposite at an amount according to the target electrical conductivity.

19. The method of claim 16, further comprising specifying a target thermal conductivity of the nanocomposite, and incorporating the nanostructures into the nanocomposite at an amount according to the target thermal conductivity.

20. A manufacturing method of a copper-based nanocomposite, comprising:
mixing a powder of a matrix material including copper, a powder of a salt, and nanostructures to form a powder mixture;
heating the powder mixture to form an intermediate material including particles of the matrix material, the nanostructures dispersed in the particles of the matrix material, and the salt disposed between the particles of the matrix material;
removing the salt from the intermediate material; and
heating, under pressure, the particles of the matrix material including the nanostructures dispersed therein to form the nanocomposite.
